(19) United States
(12) Patent Application Publication
(10) Pub. No.: US 2009/0056519 A1
(43) Pub. Date: Mar. 5, 2009

(54) AVOCADO CUTTING AND SPLITTING DEVICE

(76) Inventor: Richard E. MOORE, Chula Vista, CA (US)

Correspondence Address: FRANK G MORKUNAS, 7750 DAGGET ST, SUITE 203, SAN DIEGO, CA, 92111, US

(21) Appl. No.: 11/845,233

(22) Filed: Aug. 27, 2007

(51) Int. Cl. B26D 1/18; B26D 3/08

(52) U.S. Cl. 83/873

(57) ABSTRACT

An avocado cutter with an upper blade and a lower blade, each rotating in a forward direction with the lower blade below and forward of the upper blade defining a space therebetween. A V-shaped conveyor conveys an avocado to the upper blade which cuts to the seed of the avocado and rotates the avocado in a forward direction in the process causing the avocado to engage the lower blade and engage a V-shaped splitter to split the avocado into two sections.

### CROSS REFERENCES TO RELATED APPLICATIONS

None.

### STATEMENT REGARDING FEDERALLY-SPONSORED RESEARCH OR DEVELOPMENT

Not applicable.

### BACKGROUND

This present invention relates to an improvement in cutting avocados to the seed and to split the cut avocado into two sections to facilitate seed removal.

Avocados have become more and more popular for their versatility and arguable health-related benefits. They come in various varieties and sizes. For example, West Indian avocados produce enormous, smooth round, glossy green fruits that are low in oil and can weigh up to two pounds. Guatemalan types produce medium ovoid or pear-shaped, pebbled green fruits that turn blackish-green when ripe. The fruit or pulp of Mexican varieties are smaller (six to ten ounces) with skins that turn glossy green or black when ripe.

The pulp of avocados is deep green near the skin, becoming yellowish nearer the single large, inedible ovoid seed. The pulp is hard when harvested but softens to a buttery texture. Avocados are high in monosaturates and the oil content is second only to olives among fruits. Clinical feeding studies in humans have shown that avocado oil can reduce blood cholesterol.

To effectively obtain the pulp of an avocado, the avocado must be de-skinned and the seed must be removed. The device of the present disclosure addresses the process for efficient seed removal. Typically, an avocado is first cut through the seed. Thereafter the avocado is split into two sections. Generally one-half of the split avocado seed remains in each section. The seed from each half section must now be removed before the avocado enters the de-skinning stage.

Typically, a worker will manually remove the avocado seed from each split section by using a spoon, or similar device, or their thumb. The spoon or thumb is pressed under the seed and the seed is then pried out. This can be a tedious and labor intensive job. Because of their popularity and continued growing popularity, and commercialization of avocados, a need exists to effectively and efficiently cut and split an avocado to facilitate removal of the seed.

Many prior art devices provide for cutting of fruits to or through the seed and some split the fruit. These prior art devices are extremely complex, somewhat cumbersome, and costly to manufacture and maintain. None is as simple and as effective as the presently described device.

The objects of the device of the present disclosure are to:

a. effectively and efficiently cut an avocado to but not through the seed.

b. effectively and efficiently split the avocado into two sections after having been cut thereby exposing the seed in one section.

c. effectively and efficiently remove the seed from a split avocado.

The foregoing has outlined some of the more pertinent objects of the device of the present disclosure. These objects should be construed to be merely illustrative of some of the more prominent features and applications of the device of the present disclosure. Many other beneficial results can be attained by applying the disclosed device of the present disclosure in a different manner or by modifying the device of the present disclosure within the scope of the disclosure. Accordingly, other objects and a fuller understanding of the device of the present disclosure may be had by referring to the summary of the device of the present disclosure and the detailed description of the preferred embodiment in addition to the scope of the device of the present disclosure defined by the claims taken in conjunction with the accompanying drawings.

### SUMMARY

The above-noted problems, among others, are overcome by the device of the present disclosure. Briefly stated, the device of the present disclosure contemplates an avocado cutter and splitter having a first rotatable blade with an engaging section to be rotating in a forward direction and having a second rotatable blade with an engaging section to be rotating in a forward direction. The second rotatable blade is below and forward of the first rotatable blade defining a space-Y between the two blades. A splitter is pivotably connected to a shield which covers the non-engaging section of the first rotatable blade and which is forward of the second blade. As the two blades cut the avocado to but not through its seed, the cut avocado is pass to the splitter causing the cut avocado to be split into two sections and typically in the process to be separated from the seed. In instances when the seed is not removed, it is clearly exposed and may be easily removable.

The foregoing has outlined the more pertinent and important features of the device of the present disclosure in order that the detailed description that follows may be better understood so the present contributions to the art may be more fully appreciated. Additional features of the device of the present disclosure will be described hereinafter which form the subject of the claims. It should be appreciated by those skilled in the art that the conception and the disclosed specific embodiment may be readily utilized as a basis for modifying or designing other structures and methods for carrying out the same purposes of the device of the present disclosure. It also should be realized by those skilled in the art that such equivalent constructions and methods do not depart from the spirit and scope of the device of the present disclosure as set forth in the appended claims.

### BRIEF DESCRIPTION OF THE DRAWINGS

For a fuller understanding of the nature and objects of the device of the present disclosure, reference should be had to the following detailed description taken in conjunction with the accompanying drawings in which:

FIG. 1 is a perspective view of the major components of the device of the present disclosure.

FIG. 2 is a side elevation view of the device of the present disclosure.

FIG. 3 as taken on line 3-3 of FIG. 2 is a detailed front view of the V-shaped splitter component of the device of the present disclosure.

FIG. 4 as taken on line 4-4 of FIG. 2 is a detailed cross-section end view of the splitter component of the device of the present disclosure.

FIG. 5 is a front elevation view of the device of the present disclosure.

FIG. 6 is a detailed perspective view of the splitter component of the device of the present disclosure.

FIG. 7 is an exploded top view of the two arms of the splitter component of the device of the present disclosure.

FIG. 8 is a side view of one arm of the splitter component of the device of the present disclosure.

FIG. 9 is a detailed side view of the adjustment component of the splitter component of the device of the present disclosure.

FIG. 10 as taken on line 8-8 of FIG. 9 is a detailed top view of the adjustment component of the splitter component of the device of the present disclosure.

### DETAILED DESCRIPTION

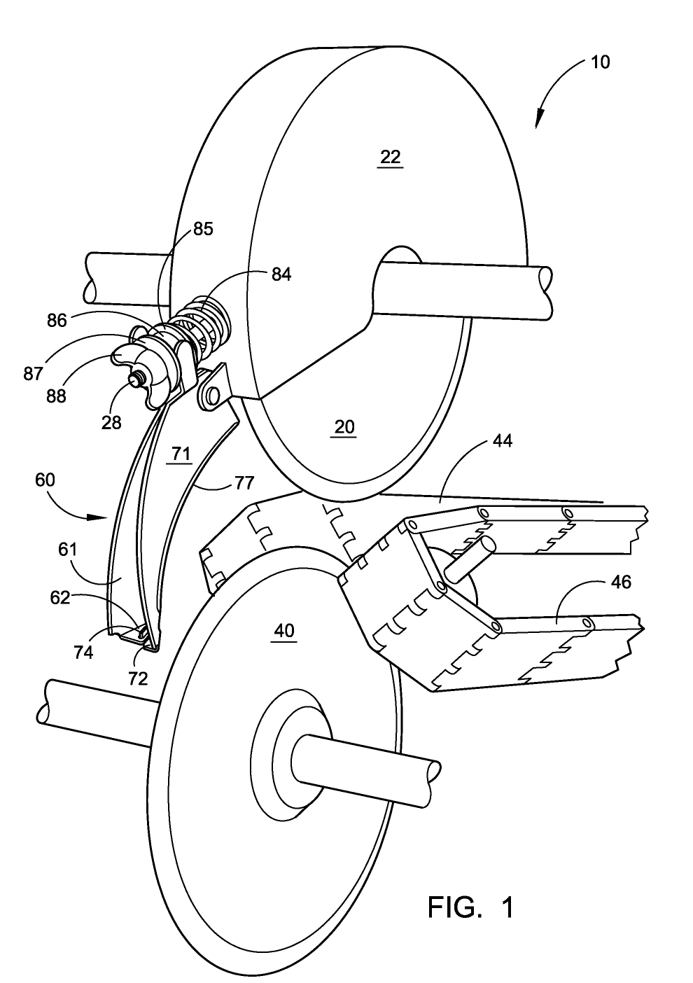

Referring now to the drawings in detail and in particular to FIGS. 1 through 5, and reference character 10 generally designates an avocado cutting and splitting device constructed in accordance with a preferred embodiment of the device of the present disclosure. The device 10 has an upper rotatable blade 20 and a lower rotatable blade 40 which is lower and forward of the upper rotatable blade 20. The space defined between the two blades is referred to as space-Y. The respective axes of rotation 21, 41 of the upper blade 20 and lower blade 40 are off-set by distance-W.

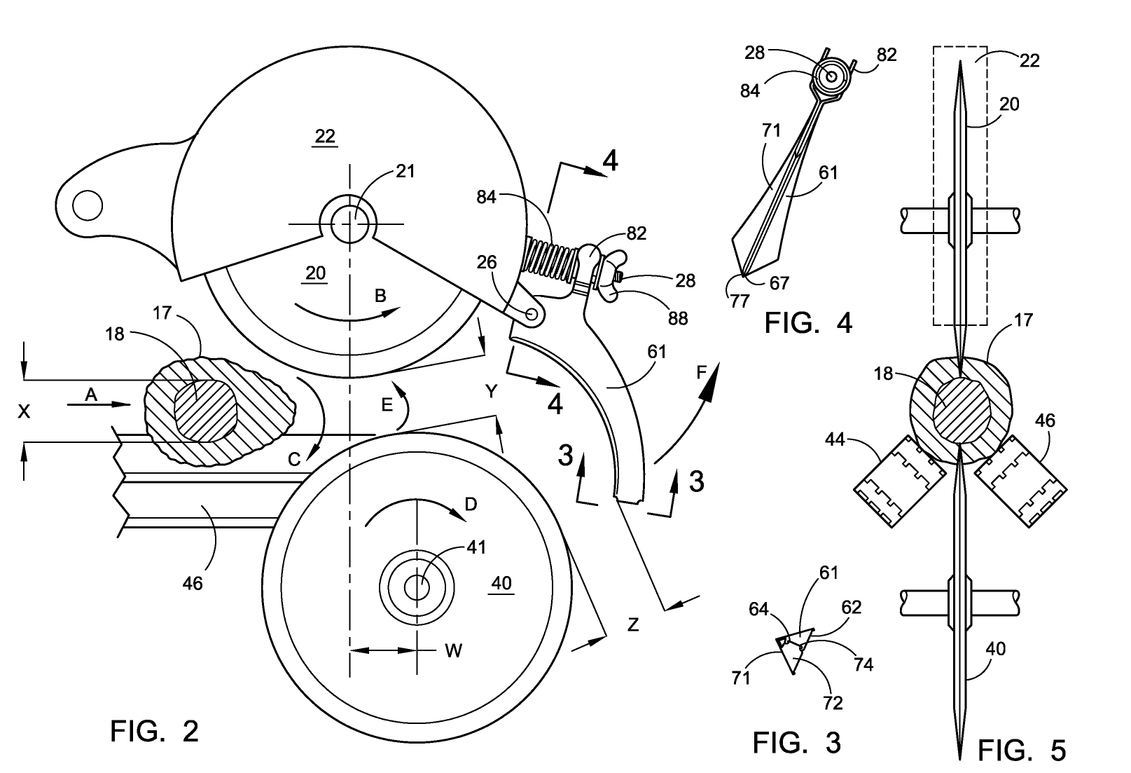

Typically the upper blade 20 should have a slower edge speed than the lower blade 40; i.e., the lower blade 40 should rotate approximately between 40% to approximately 60% faster than the rotation speed of the upper blade 20. This will cause the avocado 17 to reverse its rotation as illustrated in FIG. 2, directional arrow E.

FIG. 1 details the direction of travel of the avocado, the respective rotations of blades and avocado, and the concept described above. A conveyor belt 44, 46 moving in a forward direction as represented by Arrow A will engage the upper blade 20. The rotation speed of the upper blade 20 should be approximately 30% to approximately 50% faster than the speed of the conveyor belt 44, 46. The upper blade 20 is rotating in a forward direction as represented by Arrow B. As the faster upper blade engages the avocado 17 on the slower moving conveyor belt 44, 46, the avocado 17 will begin rotating in a forward direction as represented by Arrow C. As the avocado 17 continues being conveyed in a forward direction and rotating it will engage the even faster-rotating lower blade 40.

The lower blade 40 is also rotating in a forward direction as represented by Arrow D and is counter to the rotation of the upper blade 20. As the avocado 17 engages the lower blade 40, its rotation will reverse such that it will rotate in the direction represented by Arrow E. The upper blades 20 and the lower blade 40 are adjustable to create a distance them represented as space-Y. Space-Y may be equal to the diameter of the avocado seed 18 as represented by diameter-X or it may be substantially smaller than diameter-X. If space-Y is smaller than diameter-X, the configuration of the upper blade 20 and lower blade 40 will cut to and into the seed 18. The respective blade 20, 40 also may be adjusted completely through the seed 18 though this is not desired.

It is best, however, that the seed 18 not be cut completely through. In this manner, the seed 18 should remain intact and, as the seed 18 continues to rotate down the splitter 60 and over the widening bottom edge of the splitter 60, the two halves of the avocado 17 will typically separate from the seed 18.

Given these forces of movement and rotation in relation to the off-set axis of rotation [distance-W] will ensure that the avocado 17, as it passes over and by the faster-rotating lower blade 40, the rotation of the avocado 17 will reverse and begin rotating in the direction of Arrow E where it will continue in that matter to, down, and into the splitter 60.

Key to a proper cut to or through the seed 18 is space-Y which, as indicated above, may be increased or decreased as necessary to accommodate the seed diameter referred to as diameter-X. Space-Y may be adjusted by either moving upper blade 20 up or down as necessary or by moving the lower blade 40 up or down as necessary. If it is desired not to cut through the seed 18, it is best suited that space-Y should be approximately equal to diameter-X. Conversely, if it is desired to cut through the seed 18, it is best suited that space-Y should be considerably less than diameter-X. Such blade adjustment also accommodates for respective blade wear and sharpening through use.

The conveyor belt 44, 46 is V-shaped as best illustrated in FIG. 1 and 5. One side of the belt 44 is below and angled outward of the engaging section of the lower blade 40 and forward of its axis of rotation. The other side of the belt 46 also is below and angled outward of the engaging section of the lower blade 40 and forward of its axis of rotation. The outward angling of the conveyor belt 44, 46 is approximately between 30° and 60° with an optimum angling of approximately 45°. This configuration creates the V-shape of the conveyor belt of approximately 90° and firmly holds the conveying avocado 17 as it engages the respective cutting blades 20, 40.

After the avocado 17 is completely cut around the seed 18, it is forced by the lower blade 40 to a splitter 60 which, as the seed 18 of the cut of the avocado 17 presses into the splitter 60, the avocado and seed will be rotated by the continued rotation of the lower blade 40 pressing into the avocado 17 and/or on the seed 18 and onto and downward through the splitter 60 causing the avocado 17 to be split into two sections.

As mentioned above the upper blade 20 should be traveling approximately 30% to approximately 50% faster than the speed of the conveyor belt 44, 46; and the lower blade 40 should be traveling approximately 40% to approximately 60% faster than the speed of the upper blade 20. By way of example, where the conveyor belt 44, 46 is traveling at approximately between 50 to approximately 70 feet per minute [fpm], the upper blade 20 should be traveling at approximately between 65 to approximately 105 fpm, and the lower blade 40 should be traveling at approximately between 91 to approximately 168 fpm.

As illustrated in FIGS. 1 and 6 through 8, the splitter 60 is a unique and intricate component to the cutting and splitting device 10. The rear end of the splitter 60 is connected to a blade shield 22 which is over the non-engaging section of the upper blade 20. The rear end of the splitter 60 is pivotably movable on pivot component 26 and is adjustably and biasedly connected to the blade shield 22.

As illustrated in FIGS. 1, 2, 9, and 10, the device 10 has an adjustment component 80 for the splitter 60 which is adjacent to the tab extensions 82 on the splitter 60. A threaded rod 28 extends forward of the blade shield 22 over which a spring 84 component seats and abuts the blade shield 22. A first washer 85 is over the rod 28 and between the distal end of the spring component 84 and the tab extensions 82. A guide or bushing 86 is over the rod 28 and seats between the tab extensions 82 followed by a second washer 87 and a retaining and adjusting member [such as a wing nut or equivalent] 88 which threads onto the rod 28.

Once so configured, as the adjusting member 88 is tightened [turned toward the blade shield 22], this will cause the splitter 60 to pivot on pivot component 26 such that the front end of the splitter 60 to move in the direction of Arrow F and increase distance-Z; i.e., that distance between the cutting edge of the second blade 40 and the front end of the splitter 60. This is initially done to set the estimated or known size of the seed 18 residing in the avocado 17. This is the minimum distance. Should the seed size be larger than set, the spring component 84 within the adjustment component 80 permits additional movement in the direction of Arrow F to accommodate the variances encountered.

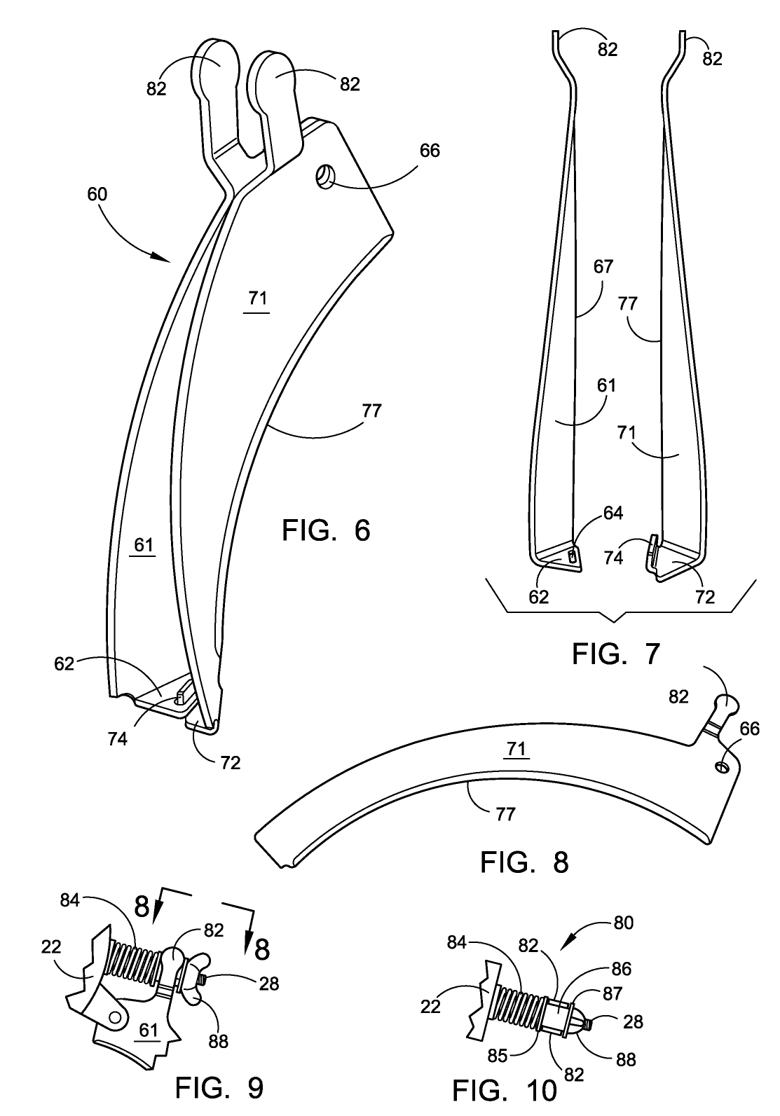

Though distance-Z should be approximately equal to diameter-X, it has been found that the device 10 operates more effectively and efficiently if distance-Z is less that diameter-X. Therefore, as the avocado 17 rotates in the direction of Arrow E down the splitter 60 and between the engaging section of the lower blade 40, the continued movement of the avocado and the V-shape at the front end of the splitter 60 force the avocado apart and splits it into two sections. This is primarily due to the shape of the splitter 60 and its two blade arms 61, 71 which, at the proximal or rear end are relatively parallel to, and substantially abutting, one another but at the distal or front end are V-shaped and apart from each other at their respective tops [see FIGS. 6 and 7].

The splitter 60 is made of two blade arms 61, 71 which are insertably removable from one another [FIGS. 6 through 8]. When the two blade arms 61,71 are connected to one another at the front end, the splitter has a clearly defined V-shape at the front end. The upper portion of the splitter 60 at the front end is open and that opening tapers closed at the rear end [see FIGS. 1, 4, and 6].

The lower portion of the splitter 60 is the point of adjacency between the two blade arms 61, 71 and these blade arms, as so connected with bottoms substantially adjacent to one another for their entire length, define a cutting or splitting edge for the lower portion. Reference is now made to FIGS. 4 and 6. The lower portion of each blade arm 61, 71 is beveled upward and outward from their respective points of adjacency as represented by reference characters 67, 77 respectively. This beveling creates a knife-like cutting and splitting component for the splitter 60.

The points of connection between the two blade arms 61, 71 at their respective front ends are the inward projecting tabs 62, 72 on the respective blade arms 61, 71. Each tab 62, 72 projects inward at the front end by approximately between 80° to approximately 100°; though an optimum angle is approximately 90°. One inward tab 62 has a slot 64, the other inward tab 72 has a rear ward angled tab 74 which is adapted to insert into slot 64 such that the lower portions of each blade arm 61, 71 come into contact with one another forming the lower edge of the V-shape.

After the two blade arms 61, 71 are so joined at the front end, the rear end of the splitter 60 is then removably connectable to the shield 22 as previously described. As the splitter 60 is so connected to the shield 22 it will retain its V-configuration and, as a cut avocado passes through the splitter 60, the avocado will be split into two sections.

Though not illustrated, the rotation of the upper and lower blades 20, 40 and movement of the conveyor belt 44, 46 are caused by conventional electric motors connected to a suitable power source. The speed of rotation of the upper and lower blades 20, 40 is independently adjustable as is the speed of the conveyor belt 44, 46.

The present disclosure includes that contained in the present claims as well as that of the foregoing description. Although this device of the present disclosure has been described in its preferred forms with a certain degree of particularity, it is understood that the present disclosure of the preferred form has been made only by way of example and numerous changes in the details of construction and combination and arrangement of parts and method steps may be resorted to without departing from the spirit and scope of the device of the present disclosure. Accordingly, the scope of the device of the present disclosure should be determined not by the embodiments illustrated, but by the appended claims and their legal equivalents.

Applicant[s] have attempted to disclose all the embodiments of the device of the present disclosure that could be reasonably foreseen. It must be understood, however, that there may be unforeseeable insubstantial modifications to device of the present disclosure that remain as equivalents and thereby falling within the scope of the device of the present disclosure.

What is claimed is:

1. An avocado cutter comprising:
a first rotatable blade with an engaging section to be rotating in a forward direction, said first rotatable blade having a shield over a non-engaging section of said first rotatable blade;
a second rotatable blade with an engaging section to be rotating in said forward direction, said second rotatable blade below and forward of said first rotatable blade defining a space-Y between said first rotatable blade and said second rotatable blade;
a splitter pivotably connected to said shield; and
conveyor means for conveying in said forward direction an avocado with a seed having a diameter-X inside to said first rotatable blade wherein said engaging section of said first rotatable blade cuts to the seed causing said avocado to rotate in said forward direction and to contact said engaging section of said second rotatable blade to thereby cut said avocado completely around said seed and thereafter to engage said splitter to split said avocado into a first section and a second section.

2. The cutter of claim 1 wherein a rotation speed of said second rotatable blade is approximately between 40% to approximately 60% faster than a rotation speed of said first rotatable blade.

3. The cutter of claim 1 wherein a rotation speed of said first rotatable blade is approximately between 30% to approximately 50% faster than a conveying speed of said conveyor means.

4. The cutter of claim 1 further comprising blade adjustment means for adjusting a distance between said first rotatable blade and said second rotatable blade to thereby increase or decrease said space-Y.

5. The cutter of claim 4 wherein said space-Y is approximately equal to diameter-X.

6. The cutter of claim 1 wherein said conveyor means comprises a first conveyor belt and a second conveyor belt each angled between approximately 30° to approximately 60° outward of said second rotatable blade and below the engaging section of said first rotatable blade.

7. The cutter of claim 1 wherein said splitter comprises a first arm and a second arm removably attachable to said first arm at a forward end and removably attachable at a rear end to said shield.

8. The cutter of claim 7 wherein said first arm has an inward projection tab at said forward end and a slot thereon, and said second arm has an inward projection tab at said forward end and a rear ward projection tab on its said inward projection tab wherein said rear ward projection tab is adapted to insert into said slot to thereby form said splitter into a V-shape configuration.

9. The cutter of claim 7 wherein said splitter further comprises a splitter adjustment means for adjusting a distance-Z between the engaging section of said second rotatable blade and the forward end of said splitter.

10. The cutter of claim 9 wherein said distance-Z is approximately equal to diameter-X.

11. The cutter of claim 9 where the inward projection tab of said first arm projects inward at an angle of approximately between 80° to approximately 100°.

12. The cutter of claim 9 wherein the inward projection tab of said second arm projects inward at an angle of approximately between 80° to approximately 100° and said rear ward projection tab projects rear ward from said inward projection tab of said second arm at an angle of approximately between 80° to approximately 100°.

13. The cutter of claim 9 wherein said splitter adjustment means comprises a rod attached to said shield projecting outward and having a threaded end, an adjusting member threadable over the threaded end of said rod, and a bias member between said shield and said adjusting member.

14. A splitter for use with a cutter for splitting cut objects, said splitter comprising:
a first arm having a forward end, a rear end, a bottom edge, and an inward projection tab at said forward end and a slot thereon;
a second arm having a forward end, a rear end, a bottom edge, an inward projection tab at said forward end and a rear ward projection tab on its said inward projection tab wherein said rear ward projection tab is adapted to insert into said slot to thereby connect said first arm to said second arm forming a V-shape configuration thereat.

15. The splitter of claim 14 where the inward projection tab of said first arm projects inward at an angle of approximately between 80° to approximately 100°.

16. The splitter of claim 14 wherein the inward projection tab of said second arm projects inward at an angle of approximately between 80° to approximately 100° and said rear ward projection tab projects rear ward from said inward projection tab of said second arm at an angle of approximately between 80° to approximately 100°.

17. The splitter of claim 14 wherein the forward end of said first arm is curved outward such that when said first arm and said second arm are connected an open space is defined above said first arm and said second at the forward end and the first arm and the second arm are abutting one another at the rear end.

18. The splitter of claim 14 wherein the forward end of said second arm is curved outward such that when said first arm and said second arm are connected an open space is defined above said first arm and said second at the forward end and the first arm and the second arm are abutting one another at the rear end.

19. The splitter of claim 14 wherein the bottom edge of said first arm is beveled upward and outward and substantially abuts the bottom edge of the second arm substantially from the rear end to the forward end.

20. The splitter of claim 14 wherein the bottom edge of said second arm is beveled upward and outward and substantially abuts the bottom edge of the first arm substantially from the rear end to the forward end.
